(19) United States
(12) Patent Application Publication
(10) Pub. No.: US 2016/0351085 A1
(43) Pub. Date: Dec. 1, 2016

(54) RECESSED LABEL MOUNT

(71) Applicant: Milspray, LLC, Lakewood, NJ (US)

(72) Inventors: Matthew L. Johnston, Bayville, NJ (US); Christian E. Steinmetz, Mickleton, NJ (US)

(73) Assignee: MILSPRAY, LLC, Lakewood, NJ (US)

(21) Appl. No.: 14/725,831

(22) Filed: May 29, 2015

(51) Int. Cl. G09F 3/12

(52) U.S. Cl. CPC G09F 3/12

(57) ABSTRACT

The invention, which is a recessed label mount suitable for attachment of a label, comprises: a solid material configured in a geometric shape, the solid material having a mounting surface for the label, a back surface, at least one side; and a fastener recess with a recess base formed in the mounting surface, the fastener recess including a through hole configured to frictionally retain at least a portion of a mechanical fastener.

### FIELD OF THE INVENTION

The present invention relates to a mounting device for holding a label, the mounting device providing a substantially flat label surface, and having a recess feature for retaining a standard thumbtack or similar mechanical fastener, wherein the placement of the mechanical fastener in the recess feature provides a means of tacking or pinning the mounting device to a support surface.

### BACKGROUND OF THE INVENTION

Traditional labeling accessories for maps and other flat surfaces, including stickers, mounted placards, color-coded or numbered pins, miniature flags, and “post-its” have been known in the art for some years. These methods of labels often require a table or key to reference the number/color, and can be difficult to remove; often leaving behind a sticky residue, or portions of the label itself. Additionally, certain such accessories support the label or sticker in an orientation that is perpendicular to the mounting surface. This orientation results in the label or other affixed item being unreadable from a typical vantage point or line of sight. For example, the use of a “stick pin flag” for attaching a label to a map or chart would result in a user viewing the photo edge-on from the vantage point of an audience member. The previously mentioned accessories are deficient in that the writing or labeling or affixing surface for the purpose of writing or labeling or affixing objects upon that surface are typically too small to accommodate complete words for a description.

What is needed is a solid, substantially flat mounting surface to which a label, a placard, a pictogram, a decoration, or adornment may be affixed, using currently-available affixing accessories, while keeping the label oriented for optimal viewing. In particular, the mounting surface should be readily attachable to a support surface which may, in common usage, be referred to as a wall, a corkboard, an office cubicle partition, a map, a wooden surface, a foam surface, and similar supports. Preferably, the solid flat surface allows easy removal of the affixed item.

### BRIEF SUMMARY OF THE INVENTION

In one aspect of the present invention, a recessed label mount suitable for attachment of a label comprises: a solid material configured in a first geometric shape, the solid material having a mounting surface for the attachment of the label, a back surface, at least one side; a fastener recess formed in the mounting surface, the fastener recess having the shape of a cylinder with a recess base, the recess base configured in a second geometric shape sized to accommodate a specified mechanical fastener head; and the fastener recess further including a through hole sized to allow insertion of a specified mechanical fastener stem.

In another aspect of the present invention, a fastenable label mount suitable for securing a label to a support surface comprises: a solid material configured in a geometric shape, the solid material having a mounting surface, a back surface, and at least one side; a fastener recess with a recess base formed in the mounting surface, the fastener recess including a through hole extending from the recess base to the back surface; and a mechanical fastener having a fastener head disposed in the fastener recess, the mechanical fastener further having a fastener stem retained in the through hole so as to extend from the back surface.

In still another aspect of the present invention, a recessed label mount suitable for attachment of a label comprises: a solid material configured in a geometric shape, the solid material having a mounting surface for the label, a back surface, at least one side; and a cylindrical recess with a recess base formed in the mounting surface, the cylindrical recess configured to accommodate a portion of a mechanical fastener, the solid material including a through hole extending from the recess base to the back surface.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is an isometric illustration of a recess label mount showing a mounting surface, in accordance with the present invention;

FIG. 2 is an isometric illustration of the back surface of the recess label mount of FIG. 1;

FIG. 3 is a cross-sectional side view of the recess label mount of FIG. 1;

FIG. 4 is a cross-sectional edge view of the recess label mount of FIG. 1;

FIG. 5 is an isometric view of the recess label mount of FIG. 1 with a mechanical fastener;

FIG. 6 is an isometric view of the recess label mount of FIG. 5 with a tapered post tip of the mechanical fastener inserted into a through hole of the recess label mount;

FIG. 7 an isometric view of the recess label mount of FIG. 5 with the mechanical fastener seated in the recess label mount; and

FIG. 8 is an oblique view of the assembled recess label mount of FIG. 7.

FIG. 9 is an isometric illustration of a recess label mount having the shape of a circle, in accordance with the present invention;

FIG. 10 is an isometric illustration of a recess label mount having the shape of an oval, in accordance with the present invention;

FIG. 11 is an isometric illustration of a wedge-shaped recess label mount, in accordance with the present invention;

FIG. 12 is an isometric illustration of a recess label mount having the shape of a triangle, in accordance with the present invention;

FIG. 13 is an isometric illustration of a recess label mount having the shape of a star, in accordance with the present invention; and

FIG. 14 is an isometric illustration of a recess label mount having the shape of a square, in accordance with the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

The disclosed recess label mount includes: (i) a counterbore, or recess, feature in a label surface, the recess feature configured to accommodate a portion of a mechanical fastener positioned to extend from the recess label mount, and (ii) a through hole extending from the recess feature to a back surface to accommodate a stem or post of the mechanical fastener, the mechanical fastener thus being configured to pierce the mounting surface with a piercing feature on the stem or post. The recess feature maintains dimensions sufficiently large so as to accommodate the fastener head, preferable in a press-fit mode. In an exemplary embodiment, the recess feature has: (i) a diameter dimension approximating, or slightly smaller than, the dimension of the head of a standard thumbtack or a “T” shaped pin, and (ii) the dimensional height of the thickness of the head of the standard thumbtack or “T” shaped pin.

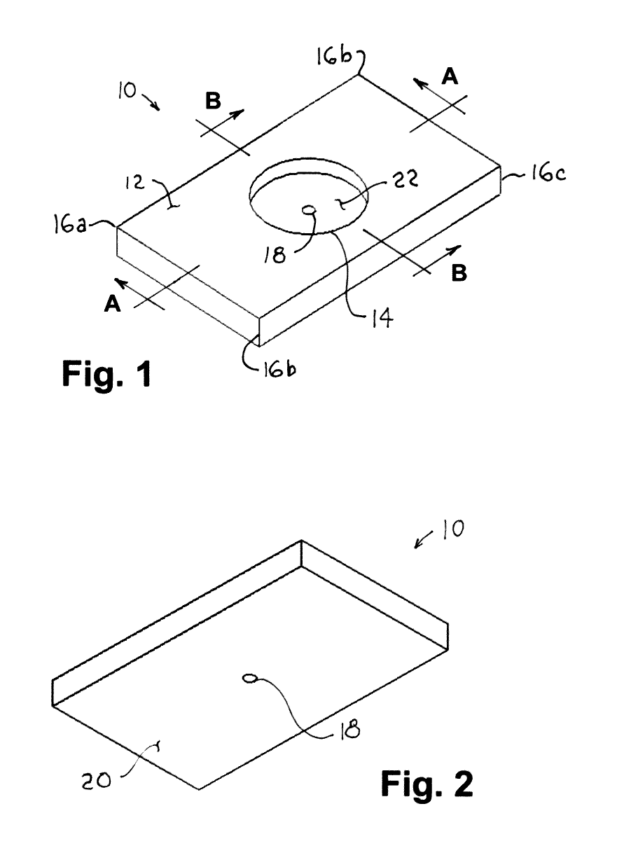

FIG. 1 shows an isometric top view of an exemplary embodiment of a recess label mount 10 formed from a solid material having a mounting surface 12 and a fastener recess 14 disposed below the mounting surface 12 of the recess label mount 10, as described in greater detail below. In the example provided, the recess label mount 10 has the shape of a substantially planar rectangular parallelepiped, and the fastener recess 14 is generally a cylindrical opening with a circular base 22. The solid material may further include a colorant (not shown) for imparting a color to the recess label mount 10, either by imbedding the colorant in the solid material or by coating the solid material with the colorant as is known in the relevant art.

It should be understood that the shape of the base of the fastener recess may comprise any geometric shape that conforms to the head of the fastener intended for placement in the fastener recess. For example, the fastener recess may be formed as a hexagonal cylinder, a slot-shaped cylinder, a multiple-sided cylinder, such as a cylinder having a plurality of flat sides, or a cylinder having a curved perimeter, such as a cylinder having an elliptical wall (not shown). A through hole 18 extends from the circular base 22 of the fastener recess 14 and terminates at a back surface 20.

The area, shape, and dimensions of the mounting surface 12 are selected such that there is provided sufficient surface area for the removable attachment of, for example, a label, a placard, a pictogram, a decoration, or an adornment, (not shown) to the mounting surface 12. Accordingly, one or more of four corners 16a-16d of the recess label mount 10 may comprise an angular corner, as shown, or a rounded corner (not shown). It should be understood that, in accordance with the present invention, the planar shape of the mounting surface 12 may vary from the rectangular shape shown and alternatively take on the shape of, for example, a trapezoid, an oval (shown in FIG. 10), or any shape compatible with the shape of the placard, pictogram, decoration, or adornment intended for removable attachment to the mounting surface 12.

Referring now to FIG. 2, showing the back surface 20, it can be seen that the through hole 18 is open at the back surface 20 to allow the insertion of a post or a stem extending from the head of a mechanical fastener. This configuration thus allows for the urging or forcing of a mechanical fastener stem into a support surface (not shown), as described in greater detail below.

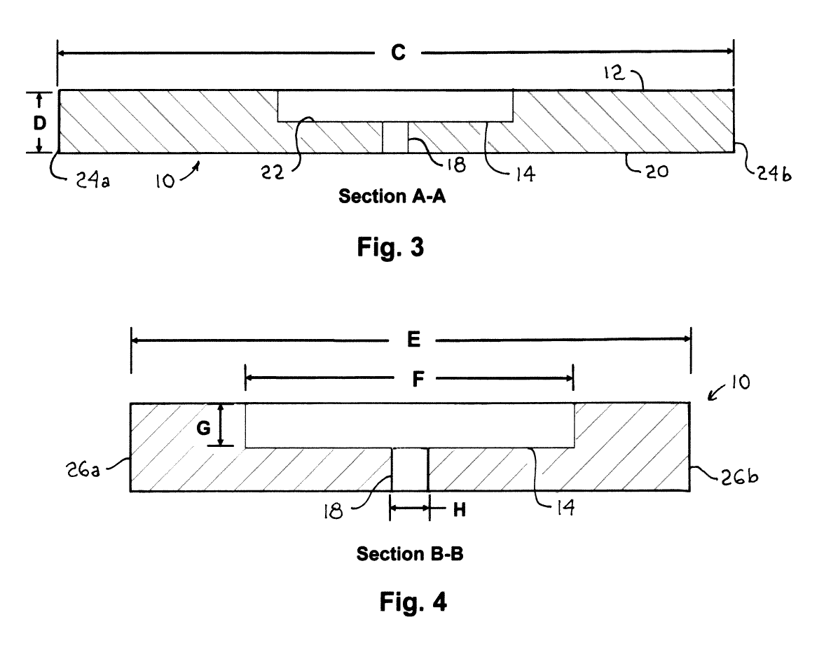

Referring now to FIG. 3, the illustration is a side cross-sectional view of the recess label mount 10, as indicated by section lines A-A shown in FIG. 1. Section A-A more clearly shows the position of the fastener recess 14 in the recess label mount 10, with the through hole 18 extending between the circular base 22 of the fastener recess 14 and the back surface 20. The overall length of the recess label mount 10, indicated by ‘C’ may be approximately 0.25 to 5.0 inch. The thickness of the recess label mount 10, indicated by ‘D’ may be approximately 0.03125 to 0.750 inch.

Referring now to FIG. 4, which is a cross-sectional end view of the recess label mount 10, as indicated by section lines B-B shown in FIG. 1, it can be seen that the recess label mount 10 has an overall width, indicated by ‘E’ which may be approximately 0.25 to 5.0 inch. Section B-B also shows that the diameter of the base recess 14, indicated by ‘F’ is smaller than the overall width ‘E’ and may be approximately 0.38 inch. The depth of the base recess 14, indicated by ‘G’ is smaller than the thickness ‘D’ and may be approximately 0.05 inch. The diameter of the through hole 18, indicated by ‘H’ may be approximately 0.04 inch.

It can be appreciated that, when the thickness ‘D’ of the recess label mount 10 is approximately 0.1 inch and the depth ‘G’ of the base recess 14 is approximately 0.05 inch, the length of the through hole 18 is approximately 0.05 inch. It should be understood that, while the above provided dimensions may be specified for an exemplary embodiment, these dimensions can be greater or smaller than the values given above, and are typically a function of the size and shape of the particular label or placard intended for attachment to the mounting surface 12 of the recess label mount 10.

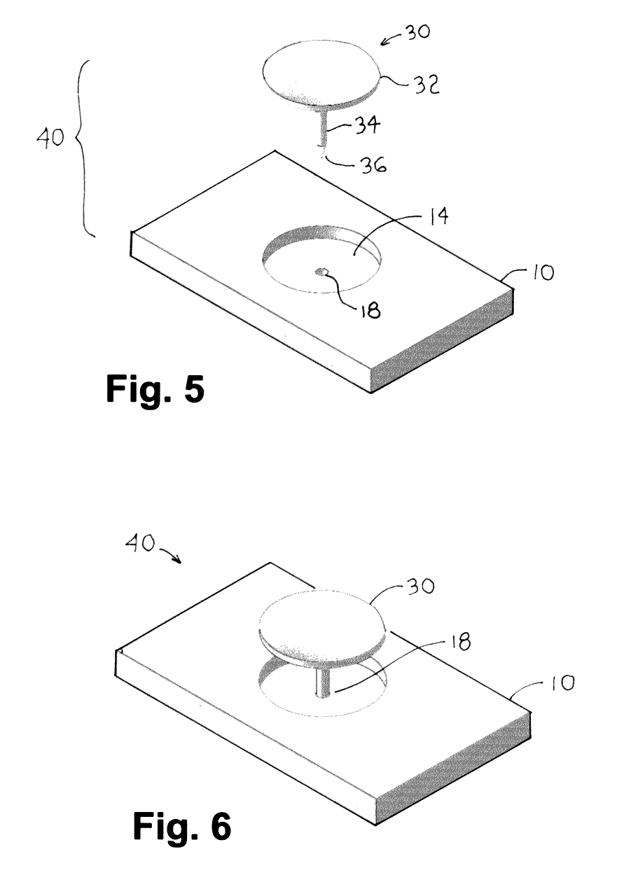

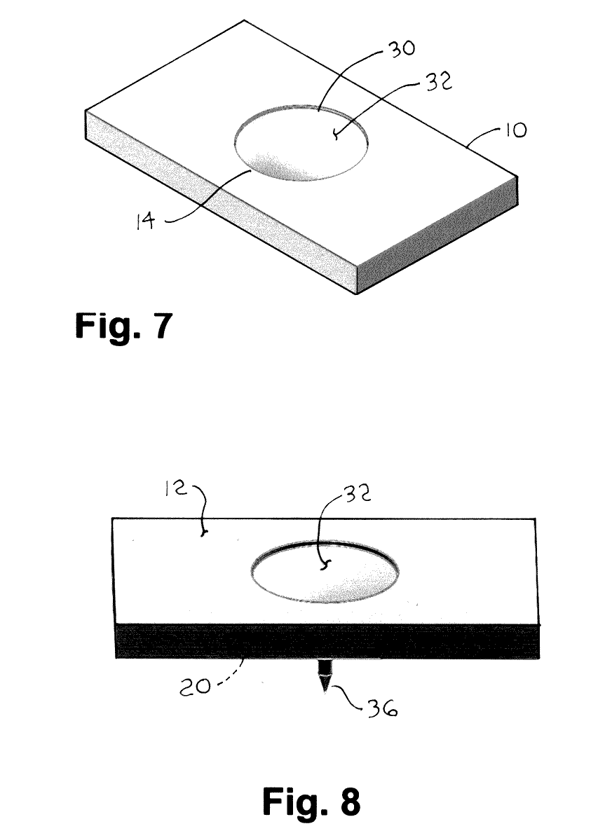

As shown in FIG. 5, the recess label mount 10 is configured to accommodate a mechanical fastener 30 having a disc-shaped fastener head 32 and a fastener stem or post 34 with a pointed or tapered post tip 36. The combination of the recess label mount 10 and the mechanical fastener 30 comprise a recess label mount set 40. In an exemplary embodiment, the user can provide his own selected mechanical fastener 30 for use with the recess label mount 10. By providing the mechanical fastener 30 as a separate component, rather than as an integral component jutting from the through hole 18, the risk of injury to the user from the tapered post tip 36 in an assembled recess label mount set 40 may be avoided or reduced.

Assembly of the recess label mount set 40 includes the step of placing the tapered post tip 36 into the through hole 18, as shown in FIG. 6. The fastener post 34 is pushed into the through hole 18 until the fastener head 32 is seated in the fastener recess 14 flush with the mounting surface 12, and the tapered post tip 36 extends beyond, and substantially normal to, the back surface 20, as shown in FIG. 8. This seating may be a press-fit configuration in that the diameter of the fastener head can be slightly larger than the diameter of the fastener recess 14. In an exemplary embodiment, a press-fit configuration may be achieved by fabricating the fastener recess as an oval or ellipse with one axis of the oval or ellipse having a smaller dimension than the diameter of the fastener head 32. It can be appreciated that a label or placard is attached to the mounting surface 12 only after the fastener head 32 has been seated in the fastener recess 14 and the top surface of the fastener head 32 lies at or below the plane of the mounting surface 12.

As can be appreciated by one skilled in the art, that the location of the fastener recess 14 in the recess label mount 10 is approximately midway between the sides 24a, 24b, shown in FIG. 3, and approximately midway between a front edge 26a and a rear edge 26b, shown in FIG. 4. That is, the mechanical fastener 30 lies approximately at the geometric center of the recess label mount 10.

In various applications, the mechanical fastener 30 may comprise, for example, a standard thumb tack, a push pin, a T-pin, nail, a sewing type pin, a hobby pin, a magnetic part, or other similar rigid devices that provide means of tacking or pinning. Accordingly, the shape of a fastener recess may have a different configuration from a cylindrical opening, depending on the geometric shape of the head of the push pin, the head of the T-pin, the head of the nail, the head of the hobby pin, or the head of the similar rigid device. In an exemplary embodiment, the recess label mount 10 may comprise: (i) a plastic, (ii) wood, (iii) a composite material, (iv) paper or a similar lightweight material, or (v) a metal or alloy, and may be formed by injection molding so as to produce the fastener recess 14 and the through hole 18 without the need for a subsequent cutting or milling step.

In an alternative embodiment, the recess label mount 10 and the mechanical fastener 30 may be provided as a single integral component by, for example: (i) emplacing or merging the mechanical fastener 30 in the fastener recess 14 as the recess label mount 10 is being fabricated, or (ii) by bonding the mechanical fastener 30 to the recess label mount 10 after the fastener 30 has been formed.

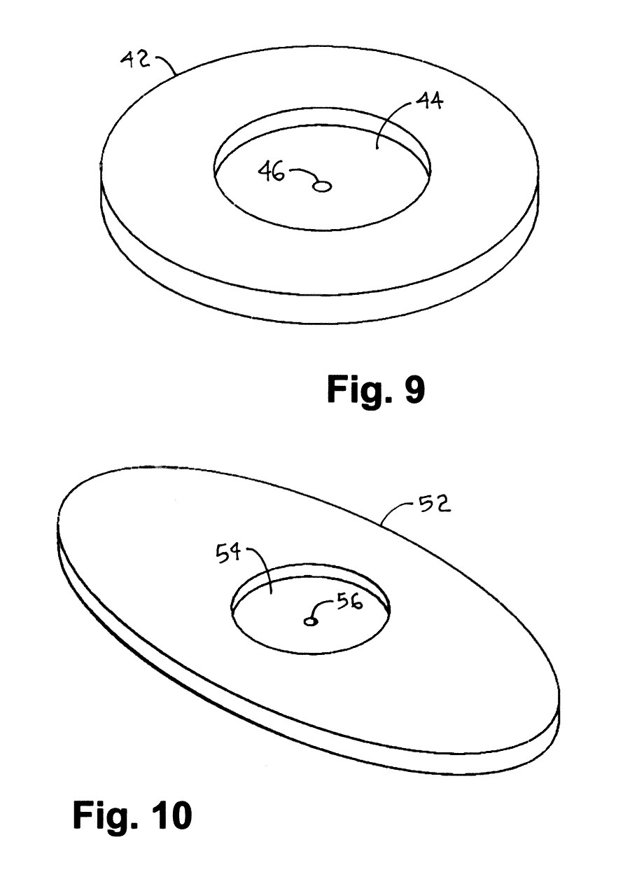

As stated above, the present invention is not limited to the geometric solid shape of a rectangular parallelepiped. FIG. 9, for example, shows an exemplary embodiment of a circular recess label mount 42 comprising a fastener recess 44 with a through hole 46 located at substantially the geometric center of the recess label mount 42. An alternative embodiment of the recess label mount 42 is shown in FIG. 10. An oval recess label mount 52 comprises a solid material having the shape of an oval disc. A fastener recess 54 includes a through hole 56 located at substantially the geometric center of the recess label mount 52.

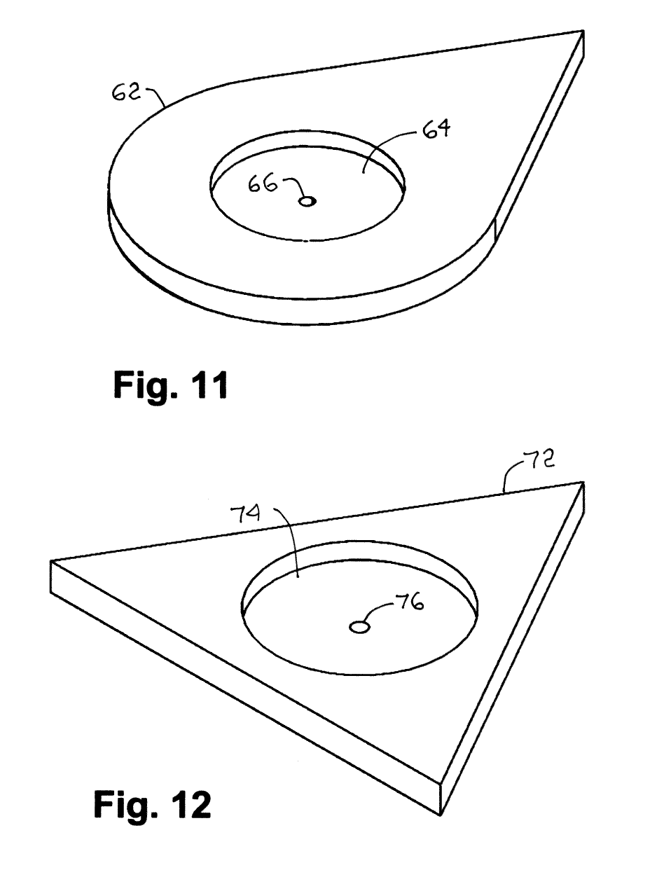

In FIG. 11, a recess label mount 62 comprises a solid material having the shape of a teardrop or wedge. The wedge recess label mount 62 includes a fastener recess 64 with a through hole 66 located in the center of the fastener recess 64. In yet another alternative embodiment, a triangular recess label mount 72 comprises a solid material having a triangular shape, with a fastener recess 74 and a through hole 76 located at substantially the geometric center of the recess label mount 72.

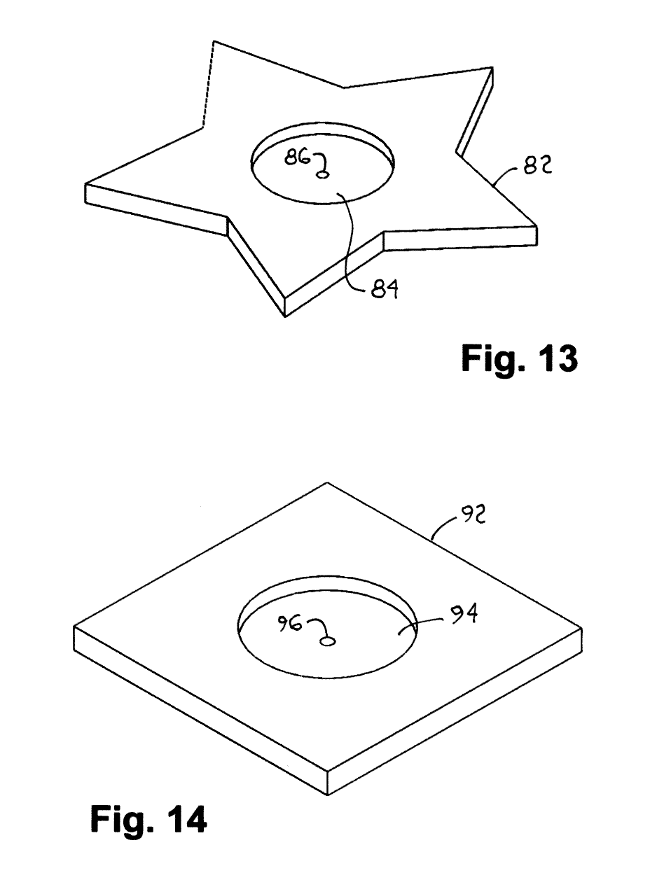

A star-shaped recess label mount 82 is shown in FIG. 13. In an exemplary embodiment, the recess label mount 82 has a through hole 86 disposed in a fastener recess 84, where the through hole 86 is located at substantially the geometric center of the recess label mount 82. FIG. 14 shows an exemplary embodiment of a square-shaped recess label mount 92. The recess label mount 92 includes a through hole 96 disposed in a fastener recess 94. It should be understood that the overall shape of a recess label mount, in accordance with the present invention, may comprise, without limit, familiar shapes other than standard geometric shapes, such as a pine tree silhouette, a fruit shape, an animal shape, or a fish shape, for example.

It should be understood that any one of the recess label mounts 42, 52, 62, 72, 82, or 92 may be used with the mechanical fastener 30, or another suitable mechanical fastener, to form a respective fastenable label mount, similar to the recess label mount set 40 shown in FIG. 5. The mechanical fastener may be frictionally retained in a through hole, or the mechanical fastener and a selected recess label mount may be formed as an integral unit.

It is to be understood that the description herein is only exemplary of the invention, and is intended to provide an overview for the understanding of the nature and character of the disclosed recess label mounts and recess label mount sets. The accompanying drawings are included to provide a further understanding of various features and embodiments of the method and devices of the invention which, together with their description serve to explain the principles and operation of the invention.

What is claimed is:

1. A recessed label mount suitable for attachment of a label, said recessed label mount comprising:
a solid material configured in a first geometric shape, said solid material having a mounting surface for the attachment of the label, a back surface, at least one side;
a fastener recess formed in said mounting surface, said fastener recess having the shape of a cylinder with a recess base, said recess base configured in a second geometric shape sized to accommodate a specified mechanical fastener head; and
said fastener recess further including a through hole sized to allow insertion of a specified mechanical fastener stem.

2. The recessed label mount of claim 1 wherein said through hole extends from said recess base to said back surface.

3. The recessed label mount of claim 1 wherein said cylinder shape comprises one of a multiple-sided cylinder and a cylinder having a curved perimeter.

4. The recessed label mount of claim 1 wherein said solid material comprises a length of about 0.25 to 5.00 inch, a width of about 0.25 to 5.000 inch, and a height of 0.03125 to 0.750 inch.

5. The recessed label mount of claim 1 wherein said first geometric shape comprises one of a rectangular parallelepiped, a circular disc, an oval disc, a wedge, a triangle, a pine tree, an animal, a fish, a fruit, and a star.

6. The recessed label mount of claim 1 wherein said solid material comprises one of a plastic, a metal, a composite material, an alloy, and paper,

7. A fastenable label mount suitable for securing a label to a support surface, said fastenable label mount comprising:
a solid material configured in a geometric shape, said solid material having a mounting surface, a back surface, and at least one side;
a fastener recess with a recess base formed in said mounting surface, said fastener recess including a through hole extending from said recess base to said back surface; and
a mechanical fastener having a fastener head disposed in said fastener recess, said mechanical fastener further having a fastener stem retained in said through hole so as to extend from said back surface.

8. The fastenable label mount of claim 7 wherein said fastener head is configured for frictional retention in said fastener recess.

9. The fastenable label mount of claim 7 wherein said fastener stem is configured for frictional retention in said through hole.

10. The fastenable label mount of claim 7 wherein said fastener stem comprises a tapered post tip.

11. The fastenable label mount of claim 7 wherein said mechanical fastener comprises one of: a thumb tack, a push pin, a T-pin, a nail, a sewing type pin, and a hobby pin.

12. The fastenable label mount of claim 7 wherein said solid material is integral with said mechanical fastener.

13. The fastenable label mount of claim 12 wherein said mechanical fastener is bonded to said solid material.

14. The fastenable label mount of claim 12 wherein said mechanical fastener is merged with said solid material during fabrication of said fastenable label mount.

15. A recessed label mount suitable for attachment of a label, said recessed label mount comprising:
a solid material configured in a geometric shape, said solid material having a mounting surface for the label, a back surface, at least one side; and
a cylindrical recess with a recess base formed in said mounting surface, said cylindrical recess configured to accommodate a portion of a mechanical fastener, said solid material including a through hole extending from said recess base to said back surface.

16. The recessed label mount of claim 15 further comprising a colorant for imparting a color to said solid material.

17. The recessed label mount of claim 15 wherein said fastener recess is configured in the shape and size of the head of at least one of a thumbtack, a push pin, a T-pin, a nail, a sewing type pin, a hobby pin, or a magnetic part, said fastener recess further having the dimensional height of the thickness of the head of said least one of said thumbtack, said push pin, said T-pin, said nail, said sewing type pin, said hobby pin, and said magnetic part
